(19) United States
(12) Patent Application Publication
(10) Pub. No.: US 2007/0088447 A1
(43) Pub. Date: Apr. 19, 2007

(54) Scheduling of industrial production processes

(75) Inventors: Alec Stothert, Westborough, MA (US); Andreas Poncet, Zurich (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 11/586,713

(22) Filed: Oct. 26, 2006

Related U.S. Application Data
(63) Continuation of application No. PCT/CH05/00231, filed on Apr. 25, 2005.

(30) Foreign Application Priority Data
Apr. 27, 2004 (EP) 04405261.1

(51) Int. Cl. G05B 13/02

(52) U.S. Cl. 700/36

(57) ABSTRACT

A rescheduling problem can be reformulated as a multi-parametric (mp-QP) optimization problem which can be solved explicitly. The subsequent exploitation of this algebraic solution is computationally inexpensive.

### FIELD

Industrial production processes and their scheduling are disclosed.

### BACKGROUND

Operators of modern industrial processes are increasingly confronted with the simultaneous tasks of satisfying technological, contractual and environmental constraints. For example, there is pressure on operators and owners to increase profit and margins while at the same time there is a public interest on sustainable and environmentally friendly use of natural resources. Profit maximization production scheduling tasks capable of handling the aforementioned requirements can often be formulated as the minimization problem of a performance index, objective function or cost function in a condensed way as follows:

$${min}_{u} {u}^{T} Q u + c u - p u$$

$$s . t . A u \leq b$$

$$u ∈ {ℜ}^{n} , c ∈ {ℜ}^{1 \times n} , p ∈ {ℜ}^{1 \times n} , Q ∈ {ℜ}^{n \times n}$$

$$A ∈ {ℜ}^{m \times n} , b ∈ {ℜ}^{m}$$

Here, the matrix Q is assumed to be symmetric (this entails no loss of generality, because any quadratic form can be rewritten as

$${\sum }_{i = 1}^{n} {\sum }_{j = 1}^{n} {Q}_{ij} {u}_{i} {u}_{j}$$

with the constraints Qⱼᵢ=Qᵢⱼ, i, j=1, . . . , n). Furthermore, the matrix Q is assumed to be positive semi-definite, in order for the optimization problem to be convex and have a global optimum solution.

In the above minimization problem, u is the production decision variable (e.g., the vector of production values indicating the quantity of each product to be produced), p is the sales price (e.g., row vector of prices obtainable for each product), Q and c are cost matrices of appropriate size that define the production cost, and A (constraint matrix) and b (constraint vector) define constraints or boundaries on the production (e.g., minimum and maximum production limits). A solution u* of the above problem gives production values or quantities of the various products for a given set of parameters p, Q, c, A and b.

However, the vectors of production costs and prices can take different values at different times. Hence a drawback of such a formulation is that the time dependent parameters, e.g., sales price p and the production limit values A and b, should be known in advance and be fixed. In practice this is not the case, as, e.g., the price values can be uncertain or the production costs might change abruptly. This implies that the optimization problem should to be re-solved in order to compute the optimum production schedule, which is known as the rescheduling problem. One approach to the rescheduling problem is to use a receding horizon or Model Predictive Control (MPC) scheme.

In the article “Using Model Predictive Control and Hybrid Systems for Optimal Scheduling of Industrial Processes”, by E. Gallestey et al., AT Automatisierungstechnik, Vol. 51, no. 6, 2003, pp. 285-293, the disclosure of which is hereby incorporated by reference in its entirety, a cascade approach is presented, based on an outer and an inner loop Model Predictive Control (MPC) scheme. The outer loop MPC algorithm computes reference schedules by using objective functions related to the plant economic goals (minimum electricity consumption and fuel usage, ageing costs, respect of contractual constraints such as customer orders or supply of raw materials, etc.). Applied to the practical case of a combined cycle power plant (CCPP), the scheduling process uses forecast prices for electricity and steam generated by the CCPP and energy demands as inputs and returns an operation schedule indicating when the gas and steam turbines should be turned on/off and what production level should be selected. Updating or re-computation of this reference schedule can be done every two or more days. The inner loop's goal is to react to deviations due to changing conditions by penalizing deviations from the reference schedule. Using real-time plant data, the corrections are computed online every hour or two. This cascade approach allows that short-term rescheduling and production plan corrections can be handled with minimum changes to the overall plant schedule, and in a way suitable for implementation under real conditions. Yet no matter how sophisticated the assignment of the changing parameters to the one of the two loops and the choice of the respective receding horizons may be, an optimization problem with appreciable computational efforts should be solved for the short-term corrections.

On the other hand, in the field of controller design, and in particular in the area of Model Predictive Control (MPC), a research effort has gone into explicit computation of MPC controllers for use in embedded environments. In the article “An Algorithm for Multi-Parametric Quadratic Programming and Explicit MPC Solutions” by P. Tondel et al., Automatica, Vol. 39, no. 3, March 2003, pp 489-497, the disclosure of which is hereby incorporated by reference in its entirety, constrained linear MPC optimization problems are investigated. The state variable is converted into a vector of parameters and the MPC problem is algebraically reformulated as a multi-parametric quadratic programming (mp-QP) problem. Explicit solutions, i.e., analytic expressions for an input variable suitable for implementation in on-line controllers are shown to exist, c.f. theorem 1 of the paper, and obtained by off-line solving the mp-QP problem. In this context, multi-parametric programming stands for solving an optimization problem for a range (e.g., a time series) of parameter values of a vector of parameters.

### SUMMARY

An industrial production schedule as disclosed herein is adaptable to changing conditions in real-time and with reasonable computational efforts. An exemplary production scheduler for an optimal scheduling of industrial production processes and a method of optimizing an industrial production schedule are disclosed.

In an exemplary embodiment, an algebraic expression or analytic function depending on parameter variables of an industrial production process can be provided for rescheduling or adaptation of the industrial production schedule to a change in the values of said parameter variables. Hence, no time-consuming optimization problem has to be solved online upon the occurrence of a changing parameter value. The algebraic expression results from a multi-parametric quadratic programming (mp-QP) reformulation of the original optimization problem involving said parameter variables as parameters. A QP-variable is defined as a transformation of the original production decision variable via augmentation or mapping. The proposed solution can be used in situations where the original optimization problem can be represented by a convex objective function that is quadratic in the decision variable and bilinear in the decision and parameter variable. No logical process related constraints need to be taken into account.

Thus, an approach based on multi-parametric programming can be used for rescheduling. An exemplary advantage is faster rescheduling computation times. Exemplary embodiments include corresponding computer programs as well.

### BRIEF DESCRIPTION OF THE DRAWINGS

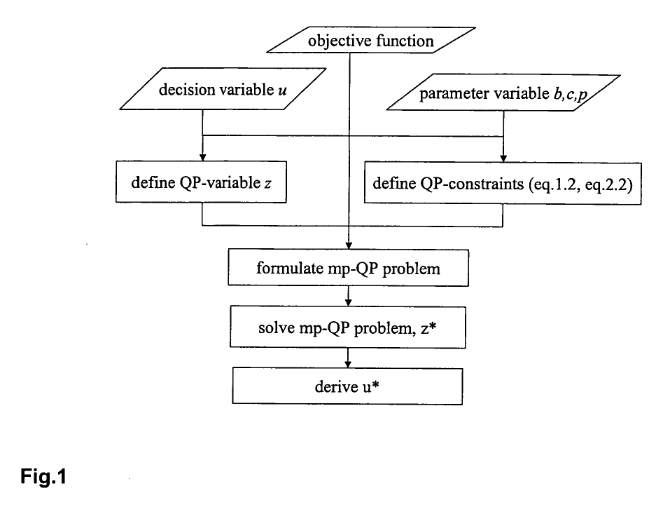

Exemplary embodiments will be explained in more detail in the following text with reference to exemplary embodiments which are illustrated in the attached drawing (FIG. 1), which shows a flow chart of an exemplary method of deriving an exemplary optimal production schedule u*(b, c, p).

### DETAILED DESCRIPTION

As the techniques for solving multi-parametric quadratic programs (mp-QP) are known in the literature as set out in the introductory part, exemplary embodiments are directed to reformulating a rescheduling problem as an mp-QP. In the following two embodiments, the sale prices p and the production costs c are considered to be time-dependent parameters of the original scheduling problem, but uncertainties on other parameters could also be treated in a similar way. For instance, the vector b of production limits could be, albeit in a straightforward manner, included in a mp-QP formulation.

In FIG. 1, a flow chart depicts the main steps for obtaining an exemplary optimal production schedule u*(b, c, p) according to an exemplary embodiment. The ingredients of the original optimization problem, i.e., the objective function for and the constraints on the original production decision variable u are redefined or transformed. In order to formulate the mp-QP problem, a QP-variable z is introduced and QP-constraints on this QP-variable z are established. As set out above, the mp-QP problem can be solved analytically, yielding an algebraic expression for the optimum QP-variable z*, from which in turn the optimum decision variable u* can be reversely determined.

Using the variable definitions as set out above, the relevant difference between the potentially uncertain or time-dependent production parameters c and p are combined into an augmenting parameter variable P by noting
P=(c−p)^{T},Pεⁿ.

A QP-variable z is then defined by augmenting the original production decision variable u with the augmenting parameter variable P
zεⁿ⁺ⁿ,z=[u^{T}(c−p)]^{T}=[uP]
and the initial rescheduling optimization problem is rewritten as an mp-QP problem of the following form:

$${min}_{z} {z}^{T} [ \begin{matrix}Q & {I}_{n} \\ 0 & 0\end{matrix} ] z . \qquad ( eq . 1.1 )$$

The constraints on the decision variable u are complemented by constraints on the augmenting parameter variable P in order to constrain the production parameters c and p to their actual values. The resulting constraints on the QP-variable z thus become

$$s . t . [ \begin{matrix}A & 0 \\ 0 & {I}_{n} \\ 0 & - {I}_{n}\end{matrix} ] z \leq [ \begin{matrix}\begin{matrix}b \\ P\end{matrix} \\ - P\end{matrix} ] \} {( c - p )}^{T} ≡ P \qquad ( eq . 1.2 )$$

According to the abovementioned article by Tondel et al., the algebraic expression or analytic solution of a quadratic program can be a piecewise-affine mapping. In consequence, the solution z of the mp-QP problem is of the explicit form

$${z}^{*} ( P ) = \{ \begin{matrix}{F}_{1} P + {G}_{1} & if & {H}_{1} P \leq {K}_{1} \\ ⋮ & & ⋮ \\ {F}_{r} P + {G}_{r} & if & {H}_{r} P \leq {K}_{r}\end{matrix} \} ,$$

where, for i=1, . . . , r, the parameters Fᵢ, Gᵢ, Hᵢ, and Kᵢ are matrices of appropriate size and the index r refers to an area in the space of the parameter P. This implies that the optimal values of the original production decision variable u*(P)=u*(c, p) can be computed directly from the parameters c, p without having to solve an optimization problem. Hence, an entire production schedule can be established given the known future parameter values, and/or can be adapted on-line upon a parameter change with a reasonable computational effort.

In a second exemplary embodiment, the requirements regarding the properties of the cost matrix Q can be slightly more stringent: Q is assumed to be (strictly) positive definite. It implies that Q is invertible, which allows to centralize the quadratic form, thereby reducing the complexity of the multi-parametric optimization problem significantly. Using the corollary below, the original scheduling problem

$${min}_{u} {u}^{T} Q u + ( c - p ) u$$

$$s . t . A u \leq b$$

can be centralized to

$$\begin{matrix}{min}_{z} {z}^{T} Q z & ( eq . 2.1 ) \\ s . t . A z \leq b + \frac{1}{2} A {{Q}^{- 1} ( c - p )}^{T} & ( eq . 2.2 )\end{matrix}$$

if and only if, according to an exemplary embodiment, Q is positive definite (which ensures, given the symmetry Q=Q^{T}, that Q is invertible). Here, the QP-variable z is defined by mapping the parameters c, p on the original production decision variable u in the following way: z=u+½Q⁻¹(c−p)^{T}. Again, from the solution z*(A, Q, c, p) the optimal production value u*=z*−½Q⁻¹(c−p)^{T} is obtained. It is to be noted that the resulting multi-parametric problem has fewer decision variables (dimension of z=n) as compared to the first embodiment (dimension of z=n+n).
Corollary:
Making use of the symmetry of Q,

$$\begin{matrix}{( y - {y}_{0} )}^{T} Q ( y - {y}_{0} ) = {y}^{T} Q y - {y}^{T} Q {y}_{0} - {y}_{0}^{T} Q y + {y}_{0}^{T} Q {y}_{0} \\ = {y}^{T} Q y + {d}^{T} y + {y}_{0}^{T} Q {y}_{0}\end{matrix}$$

where d=−2Qy₀ and hence

$${y}_{0} = - \frac{1}{2} {Q}^{- 1} d .$$

It follows that

$${min}_{y} {y}^{T} Q y + {d}^{T} y + {y}_{0}^{T} Q {y}_{0}$$

is equivalent to

$${min}_{y} {y}^{T} Qy + {d}^{T} y$$

as the term y₀^{T}Qy₀ is constant in the optimization variable y.

Those skilled in the art will appreciate that the presently described system, process, or method can be implemented on a computer system. The computer system can include at least one of a processor, a user interface, a display means, such as a monitor or printer, and/or a memory device. In at least one embodiment, the results of the presently described system, process and/or method are presented to a user, such as by presenting audio, tactile and/or visual indications of the results. Alternatively, in at least one embodiment, the results are presented to another device that can alter the operation of yet another device based on the results of the claimed system, process or method.

For example, a computer complemented production scheduler, as described herein can be stored in a computer memory, for execution by a process, to schedule tasks within an industrial production processor. The production scheduler can be stored in any computer readable medium (e.g., hard disk, CD, and so forth). Outputs from the processor can, for example, be used to control on/off switches associated one or more gas and/or steam turbines. Inputs to the process can be data from, for example, sensors or data entry devices (e.g., sensors, keyboards or other data devices) for supplying input parameters.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A production scheduler for scheduling an industrial production process determined by
a decision variable (u) and constraints (A, b) on the decision variable (u);
parameter variables (b, c, p) representing generalized limits, costs and revenues;
a positive semi-definite cost matrix (Q);
an objective function depending quadratically, via the cost matrix (Q), on the decision variable (u) and depending bilinearly on the decision variable (u) and the parameter variables (b, c, p), wherein the scheduler comprises:
computing means for calculating an optimal production schedule u* for a given set of parameter values; and
computing means for evaluating an algebraic expression for the production schedule u*(b, c, p) as a function of the parameter variables (b, c, p).

2. The production scheduler according to claim 1, wherein the algebraic expression for the production schedule u*(b, c, p) is obtained by
a) formulating a multi-parametric quadratic programming (mp-QP) problem, including:
a QP-variable (z) being defined based on the decision variable (u) and the parameter variables (b, c, p);
the objective function being rewritten in general quadratic form (eq. 1.1, eq. 2.1) in the QP-variable (z);
linear constraints on the QP-variable (z) (eq. 1.2, eq. 2.2) being defined based on the constraints (A, b) on the decision variable (u) and the parameter variables (b, c, p);
b) solving the mp-QP problem for an algebraic expression of the QP-variable z as a function of the parameter variables (b, c, p); and
c) deriving the algebraic expression for the production schedule u*(b, c, p) from the algebraic expression of the optimal QP-variable z*.

3. A method of optimizing a production schedule of an industrial production process determined by
a decision variable (u) and constraints (A, b) on the decision variable (u);
parameter variables (b, c, p) representing generalized limits, costs and revenues;
a positive semi-definite cost matrix (Q);
an objective function depending quadratically, via the cost matrix (Q), on the decision variable (u) and depending bilinearly on the decision variable (u) and the parameter variables (b, c, p), wherein an algebraic expression for the optimal production schedule u*(b, c, p) as a function of the parameter variables (b, c, p) is obtained by a method comprising:
a) formulating a multi-parametric quadratic programming (mp-QP) problem, including:
a QP-variable (z) being defined based on the decision variable (u) and the parameter variables (b, c, p);
the objective function being rewritten in general quadratic form in the QP-variable (z); and
linear constraints on the QP-variable (z) being defined based on the constraints (A, b) on the decision variable (u) and the parameter variables (b, c, p);
b) solving the mp-QP problem for an algebraic expression of the QP-variable z* as a function of the parameter variables (b, c, p); and
c) deriving the algebraic expression for the production schedule u*(b, c, p) from the algebraic expression of the QP-variable z, wherein the algebraic expression for the production schedule u*(b, c, p) obtained is evaluated as a function of the parameter variables (b, c, p).

4. The method according to claim 3, wherein the algebraic expression for the production schedule u*(b, c, p) is evaluated on-line upon a change in the value of a parameter variable (b, c, p).

5. The method according to claim 3, wherein the QP-variable (z) has the twofold dimension as the decision variable (u) and is obtained by augmenting the decision variable (u) with an augmenting parameter variable (P) equal to a difference between the parameter variables (c−p), and wherein constraints on the QP-variable (z) constrain the augmenting parameter variable (P) to its given value.

6. The method according to claim 3, wherein the matrix Q is positive definite, wherein the QP-variable (z) has the same dimension as the decision variable (u) and is obtained by mapping the parameter variables (c, p) on the decision variable (u).

7. The method according to claim 3, wherein the mp-QP problem is of a form
$${min}_{z} {z}^{T} [ \begin{matrix}Q & {I}_{n} \\ 0 & 0\end{matrix} ] z$$
and wherein:
$$s . t . A z \leq b + \frac{1}{2} A {{Q}^{- 1} ( c - p )}^{T}$$

8. The method according to claim 5, wherein:
$$s . t . [ \begin{matrix}A & 0 \\ 0 & {I}_{n} \\ 0 & - {I}_{n}\end{matrix} ] z \leq [ \begin{matrix}b \\ P \\ - P\end{matrix} ] \} {( c - p )}^{T} ≡ P$$

9. A computer implemented method for scheduling an industrial production process comprising:
receiving a decision variable and constraints on the decision variable;
receiving parameter variables representing generalized limits, costs and revenues;
calculating a production schedule for a given set of the parameter values using a positive semi-definite cost matrix and an objective function depending quadratically, via the cost matrix, on the decision variable and depending bilinearly on the decision variable and the parameter variable; and
evaluating an algebraic expression for the production schedule as a function of the parameter variables.

10. The method according to claim 9, wherein the algebraic expression for the production schedule is evaluated on-line upon a change in the value of a parameter variable.
